(19) United States
(12) Patent Application Publication
(10) Pub. No.: US 2016/0289972 A1
(43) Pub. Date: Oct. 6, 2016

(54) Gutter Bracket

(71) Applicant: CRJ Gutters, Victoria, MN (US)

(72) Inventor: Craig Johnson, Victoria, MN (US)

(73) Assignee: CRJ Gutters, Victoria, MN (US)

(21) Appl. No.: 15/066,055

(22) Filed: Mar. 10, 2016

Related U.S. Application Data
(60) Provisional application No. 62/139,875, filed on Mar. 30, 2015.

(51) Int. Cl. E04D 13/072; E04D 13/076; F16M 13/02

(52) U.S. Cl. CPC E04D 13/0722; F16M 13/022; E04D 13/076

(57) ABSTRACT

The invention is directed to a pivotal gutter bracket having a support brace having a horizontal section having a distal working end. The working end has a first prong and a second prong defining a pivot receiving channel and an axial channel between the first prong and the second prong. The gutter bracket also has a gutter retaining frame having a pivot support and a pivot rotatably engaged to the pivot receiving channel. The gutter retaining frame has a first operative position when the gutter retaining frame is disposed upwardly, and a second operative position where the gutter retaining frame is disposed downwardly to facilitate removal of debris from a gutter.

### CROSS-REFERENCE TO RELATED APPLICATIONS

This application claims priority to U.S. Provisional Patent Application No. 62/139,875, filed Mar. 30, 2015, entitled Gutter Bracket, which is incorporated by reference herein in its entirety.

### FIELD OF THE INVENTION

In some embodiments, the present invention is generally directed to gutter brackets, and the cleaning of gutters, to remove debris from the gutters, and to prevent the accumulation of water and/or ice within the gutters, minimizing risk of damage to a structure.

### BACKGROUND

In the past the cleaning of gutters for residential and/or commercial structures has been difficult and potentially hazardous. In the past, an individual cleaning a gutter was required to climb a ladder and manually remove debris. Alternatively, spray devices have been utilized for insertion into a gutter where an individual had previously climbed a ladder, or remained on the ground and used an extension/wand device to position a spray nozzle within a gutter. Pressurized water and/or cleaning liquid was sprayed into the gutter to clean and remove debris. The use of water and/or cleaning fluid in many cases did not provide an acceptable result, because of the clogging of a downspout necessitating manual removal of debris.

Other types of devices have been used to attempt to keep gutters clean, including covers to minimize accumulation of debris within a gutter.

In the past, gutters accumulating debris, as located in climates experiencing temperatures below freezing, will cause a water flow blockage, resulting in icing, formation of ice dams, and/or icicles. The formation of ice in gutters also occurs in gutters utilizing a cover. In the past, the accumulation of ice on or proximate to, a roof has frequently caused damage to the roof, resulting in water damage within a structure. No device is currently known which facilitates the convenient and relatively easy cleaning of a gutter to prevent accumulation of debris and prevent the formation of ice, ice dams, and/or icicles proximate to a roof of a structure.

The art referred to and/or described above is not intended to constitute an admission that any patent, publication or other information referred to herein is “prior art” with respect to this invention. In addition, this section should not be construed to mean that a search has been made or that no other pertinent information as defined in 37 C.F.R. §1.56(a) exists.

All U.S. patents and applications, and all other published documents mentioned anywhere in this application are incorporated herein by reference in their entirety.

Without limiting the scope of the invention, a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided for the purposes of complying with 37 C.F.R. §1.72.

### GENERAL DESCRIPTION OF THE INVENTION

The disclosed invention generally relates to a gutter bracket, where the gutter bracket includes a support brace, the support brace having a vertical section and a horizontal section, the horizontal section having a distal working end comprising a pivot retainer which in some embodiments may be a pivot receiving channel. The gutter bracket may also include a gutter retaining frame, the gutter retaining frame having a U-shaped gutter support, a pivot support, and a pivot engaged to said pivot support, the pivot being rotatably engaged to the pivot retainer or pivot receiving channel, where the gutter retaining frame has a first operative position where the gutter retaining frame is disposed upwardly to receive moisture, and a second operative position where the gutter retaining frame is disposed downwardly to facilitate removal of debris.

In some embodiments, the support brace is substantially “L” shaped, having a vertical section and a horizontal section, where the vertical section is secured the vertical section of a soffit or other portion of a structure adjacent to the lower lip of a roof.

In some embodiments, the support brace is shaped to receive the exterior shape of the gutter retaining frame which in some embodiments may be “U” shaped.

In some embodiments, the distal working end of the support brace includes a first prong and a second prong which may be integral with, or attached to, the horizontal section of the support brace.

In some embodiments, the first and second prongs each define the pivot retainer which may be a pivot receiving channel there between.

In some embodiments, an axial channel is preferably perpendicular to the pivot retainer or pivot receiving channel and is disposed between the first and second prongs extending toward a structure along a longitudinal axis as established by the horizontal section of the support brace.

In some embodiments, the axial channel may include an angled ramp which is disposed toward the distal working end.

In some embodiments, the angled ramp provides a bearing surface which may function as a positioning stop against the pivot support during the pivotal rotation of the gutter retaining frame downwardly relative to the support brace.

In some embodiments, the support brace may be a single integral component formed of metal, plastics and/or composite materials or combinations thereof. In other embodiments, the support brace may be formed of one or more different components as releasably or permanently secured together, and each component may be formed of metal, plastic, or composite materials or combinations thereof.

In some embodiments, the gutter retaining frame is substantially “U” shaped defining an interior pocket which is constructed and arranged to receive a standard shaped gutter.

In some embodiments, the gutter retaining frame includes a first vertical wall which in a first operative position is adjacent to the first vertical interior surface of the support brace.

In some embodiments, the gutter retaining frame also includes a second angled wall, a bottom, a third angled wall and a fourth vertical wall.

In some embodiments, in a first operative position, the second angled wall is disposed proximate to the second angled inner surface, and the bottom is positioned proximate to the third angled inner surface.

In some embodiments, an attachment hook is located at the upper edge of each of the first vertical wall and the fourth vertical wall, where the attachment hooks are constructed and arranged to securely clip and engage the upper edges of a gutter to releasably secure the gutter to the gutter retaining frame.

In some embodiments, a pivot support extends downwardly from the gutter retaining frame proximate to the interface between the bottom and the third angled wall.

In some embodiments, a substantially cylindrical pivot is integral with or releasably secured to the pivot support where the pivot is constructed and arranged for releasable positioning within the pivot retainer or pivot receiving channel.

In some embodiments, the pivot support includes an angled bearing edge which is proximate to, or in contact with, the fourth angled inner surface in the first operative position.

In some embodiments, the pivot support also includes an angled exterior bearing edge which is constructed and arranged to pass through the axial channel and to be positioned proximate to, or engaged with, the angled ramp when the gutter retaining frame and gutter have been fully rotated away from a roof into a second operative cleaning position, where the gutter is disposed downwardly.

In some embodiments, the adjustable positioning of the gutter retaining frame relative to the support brace occurs by the rotational engagement of the pivot and the pivot support relative to the pivot retainer or pivot receiving channel and axial channel of the distal working end of the horizontal section of the support brace.

In some embodiments, in the first operative position, the gutter retaining frame is disposed upwardly to position a gutter to receive moisture from a roof. In a second operative position, the gutter retaining frame may be rotated by an individual downwardly and outwardly away from the vertical section of the support brace via the pivot, to position a gutter downwardly toward the ground. An individual may then use gravity, spray devices, brushes, or other cleaning devices to clean a gutter and to remove accumulated debris. Upon the completion of cleaning activities, an individual may then rotate the gutter retaining frame upwardly back into the first operative position relative to the support brace and roof to capture moisture.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE DRAWINGS

FIG. 1 is an isometric environmental view of one alternative embodiment of the gutter bracket engaged to a gutter proximate to a roof.

FIG. 2 is an alternative isometric environmental view of one alternative embodiment of the gutter bracket engaged to a gutter disposed outwardly from a roof.

FIG. 3 is a detail side view of one alternative embodiment of a gutter retaining frame.

FIG. 4 is a detail side view of one alternative embodiment of a support brace.

FIG. 5 is a detail side view of one alternative embodiment of the gutter bracket disposed between the first operative position and a second operative position.

FIG. 6 is a detail bottom isometric view of one alternative embodiment of the distal working end of the support brace.

FIG. 7 is a detail top isometric view of one alternative embodiment of the distal working end of the support brace.

FIG. 8 is a detail isometric view of one alternative embodiment of the pivotal engagement of the gutter retaining frame to the support brace.

### DETAILED DESCRIPTION OF THE PREFERRED EMBODIMENTS

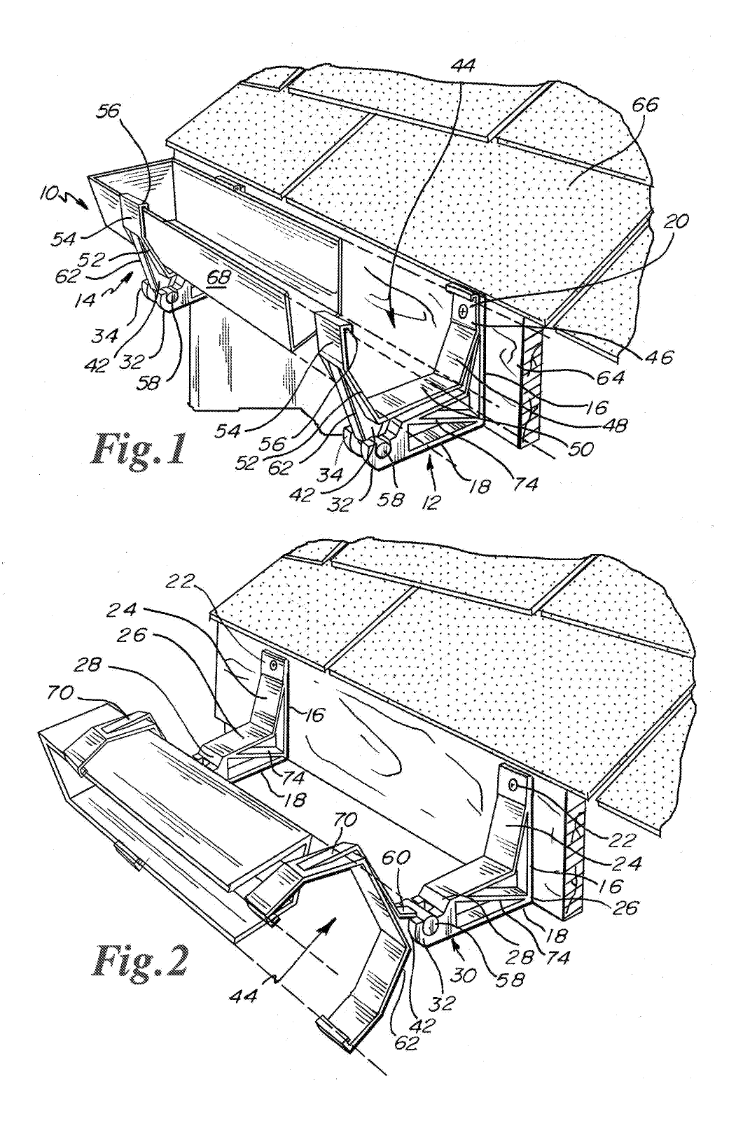

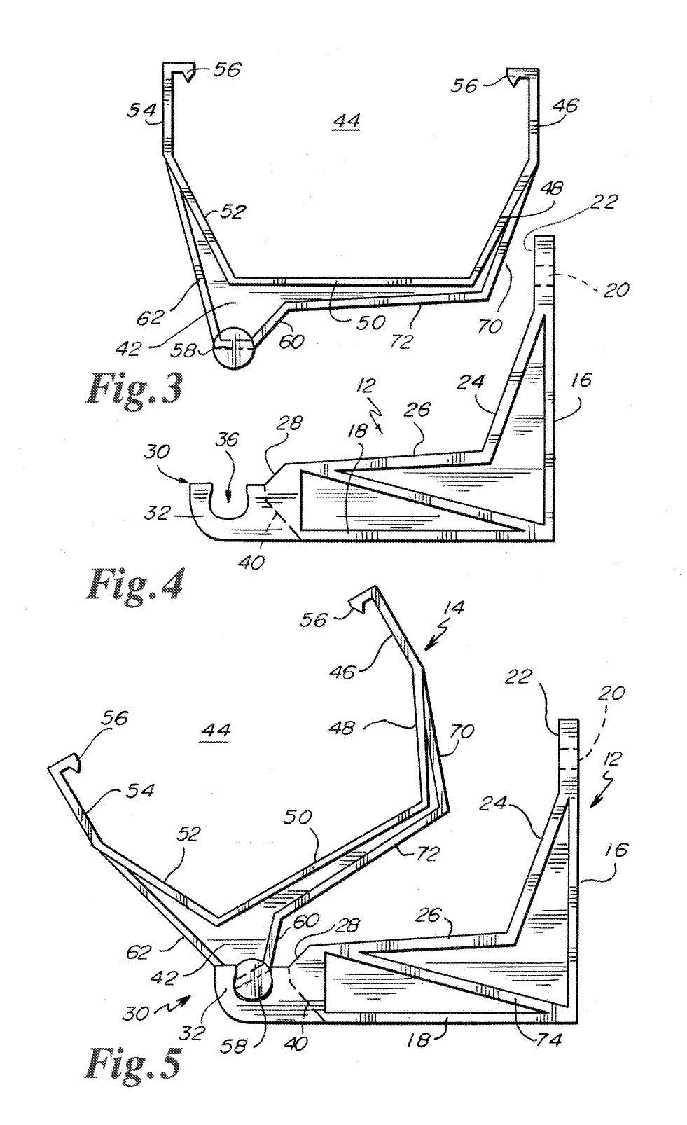

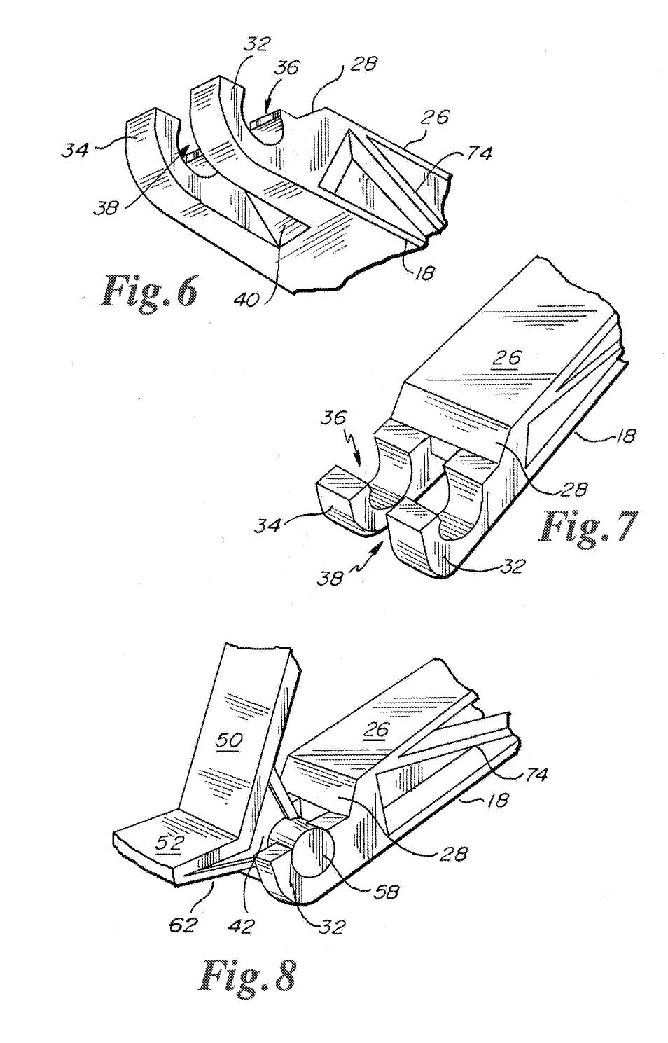

As shown in FIGS. 1 through 8 the invention in alternative embodiments is directed to a pivotal gutter bracket generally identified by the reference number 10. In some embodiments the gutter bracket 10 is formed of a support brace 12 which is pivotally coupled to a gutter retaining frame 14.

In some embodiments, the support brace 12 is substantially “L” shaped, having a vertical section 16 and a horizontal section 18. In some embodiments the vertical section 16 includes at least one aperture 20 which receives a fastener to secure the vertical section 16 to a soffit 64 or other portion of a structure adjacent to the lower lip or edge of a roof 66. In some embodiments the horizontal section 18 extends outwardly from the vertical section 16 at an angle of approximately 90°. This angle may be adjusted as required for use with a particular structure and gutter 68 assembly. In some embodiments, the interior of the support brace 12 includes a first vertical inner surface 22, a second angled inner surface 24, a third angled inner surface 26, and a fourth angled inner surface 28. The first vertical inner surface 22, second angled inner surface 24, and the third angled inner surface 26 preferably form a shape which may be described as at least a portion or as one half of a “U” shape. The upper edge and surface of the support brace 12 is preferably shaped to receive the exterior shape of the gutter retaining frame 14 which may be a “U” shape in some embodiments. In some embodiments, the third angled inner surface 26 may include a slight angle relative to a horizontal line and in other embodiments the third angled inner surface 26 may be substantially horizontal. In some alternative embodiments a curved transition may exist between each of the first vertical inner surface 22, second angled inner surface 24, third angled inner surface 26, and fourth angled inner surface 28. In alternative embodiments the interior of the support brace 12 may be curved.

In some embodiments, the distal working end 30 of the support brace 12 includes a first prong 32 and a second prong 34 which may be integral with, or attached to, the horizontal section 18 of the support brace 12. The first and second prongs 32 and 34 are each shaped to define a pivot retainer which may be a pivot receiving channel 36. An axial channel 38 is preferably perpendicular to the pivot retainer or pivot receiving channel 36 and is disposed between the first and second prongs 32, 34. The axial channel 38 extends along a longitudinal axis established by the horizontal section 18. The axial channel 38 may include an angled ramp 40 which is disposed away from the top of the distal working end 30 rearwardly and downwardly toward the horizontal section 18 and vertical section 16. The angled ramp 40 provides a bearing surface which may function as a positioning stop against an angled exterior bearing edge 62 during the pivotal rotation of the gutter retaining frame 14 relative to the support brace 12.

In some embodiments, the support brace 12 may be a single integral component formed of metal, plastics and/or composite materials or combinations thereof. In some embodiments, the support brace 12 may be formed of one or more different components as releasably or permanently secured together, and each component may be formed of metal, plastic, or composite materials or combinations thereof.

In some embodiments, the gutter retaining frame 14 is substantially “U” shaped defining an interior pocket 44 which is constructed and arranged to receive a standard shaped gutter 68. The gutter retaining frame 14 may include a first vertical wall 46 which in a first operative position is adjacent to the first vertical interior surface 22. The gutter retaining frame 14 may also include a second angled wall 48, a bottom 50, a third angled wall 52 and a fourth vertical wall 54. In the first operative position the second angled wall 48 may be disposed proximate to the second angled inner surface 24, and the bottom 50 may be positioned proximate to the third angled inner surface 26. An attachment hook 56 is located at the upper edge of each of the first vertical wall 46 and the fourth vertical wall 54. The attachment hooks 56 are constructed and arranged to securely clip and engage the upper edges of a gutter 68 to releasably secure the gutter 68 within the pocket 44 of the gutter retaining frame 14.

In some embodiments the bottom 50 may include a slight angle relative to a horizontal line and in other embodiments the bottom 50 may be substantially horizontal. In some alternative embodiments a curved transition may exist between each of the first vertical wall 46, second angled wall 48, bottom 50, third angled wall 52 and fourth vertical wall 54. In alternative embodiments the pocket 44 of the gutter retaining frame 14 may be curved.

In some embodiments, a pivot support 42 extends downwardly from the gutter retaining frame 14 proximate to the interface between the bottom 50 and the third angled wall 52. In some embodiments, a substantially cylindrical pivot 58 is integral with or releasably secured to the pivot support 42. In some embodiments the pivot 58 is constructed and arranged for releasable and rotatable positioning within the pivot retainer or pivot receiving channel 36. In some embodiments, the pivot support 42 includes an angled bearing edge 60 which is proximate to, or in contact with, the fourth angled inner surface 28 in the first operative position. In some embodiments, the pivot support 42 also includes an angled exterior bearing edge 62 which is constructed and arranged to pass through the axial channel 38 and to be positioned proximate to, or engaged with, the angled ramp 40 when the gutter retaining frame 14 and gutter 68 has been fully rotated away from a roof 66 into a second operative cleaning position, where the gutter 68 is disposed downwardly. The adjustable positioning of the gutter retaining frame 14 relative to the support brace 12 occurs by the rotational engagement of the pivot 58 and the pivot support 42 relative to the pivot retainer or pivot receiving channel 36 and axial channel 38 of the distal working end 30 of the horizontal section 18 of the support brace 12.

In the first operative position the gutter retaining frame 14 is disposed upwardly to position a gutter 68 to receive moisture from a roof 66. In a second operative position, the gutter retaining frame 14 may be rotated by an individual downwardly and outwardly away from the roof 66 and vertical section 16 by the pivot 58, to position a gutter 68 downwardly toward the ground. An individual may then use gravity, spray devices, brushes, or other cleaning devices to clean a gutter 68 and to remove accumulated debris. Upon the completion of cleaning activities, an individual may then rotate the gutter retaining frame 14 upwardly back into the first operative position relative to a roof 66.

In some embodiments the bottom surface of the second angled wall 48 and the bottom 50 include an elevated first rail 70 and an elevated second rail 72 respectively. The elevated first rail 70 and the elevated second rail 72 in some embodiments function as a bearing surface relative to the second angled inner surface 24 and the third angled inner surface 26 respectively.

In some embodiments the design of the pivotal gutter bracket 10 disposes the gutter 68 at a slight angle towards a structure, where the lowest portion of the interior of the gutter 68 will be proximate to the corner between the bottom 50 and the second angled wall 48 in the first operative position. This location of the gutter retaining frame 14 disposes the gutter 68 in an upright position and creates an offset center of rotation or center of gravity where the gutter 68 does not rotate or separate away from the soffit 64 and/or roof 66 when the gutter 68 is either empty, exposed to moisture, ice, or debris. The shape of the support brace 12 and the gutter retaining frame 14 maintains the gutter 68 in an upright first operative position until such time as the fourth vertical wall 54 and/or gutter 68, proximate to the fourth vertical wall 54 is grasped or manipulated by a hand or tool to rotate the gutter retaining frame 14 away from the support brace 12 to the second operative position to clean the interior of the gutter 68 of debris.

In some embodiments either the vertical section 16 or the horizontal section 18 may include additional support members 74 to improve the structural integrity of the gutter retaining frame 14.

In some embodiments the vertical section 16 of the support brace 12 has a height dimension of approximately 4 inches. In an alternative embodiment the vertical section 16 may have a height dimension greater or less than 4 inches which may depend on the size dimensions of the gutter 68.

In some embodiments the vertical section 16 of the support brace 12 has a width dimension of approximately 1 1/8 inches. In an alternative embodiment the vertical section 16 may have a width dimension greater or less than 1 1/8 inches which may depend on the size dimensions of the gutter 68.

In some embodiments the vertical section 16 may have any number and/or size of apertures for receipt of fasteners to attach the pivotal gutter bracket 10 to a structure or soffit 64 proximate to a roof 66.

In some embodiments the horizontal section 18 of the support brace 12 has a length dimension of approximately 4 5/8 inches. In an alternative embodiment the horizontal section 18 may have a length dimension greater or less than 4 5/8 inches which may depend on the size dimensions of the gutter 68.

In some embodiments the horizontal section 18 of the support brace 12 has a width dimension of approximately 1 1/8 inches. In an alternative embodiment the horizontal section 18 may have a width dimension greater or less than 1 1/8 inches which may depend on the size dimensions of the gutter 68.

In some embodiments the gutter retaining frame 14 has a height dimension of approximately 4 inches. In alternative embodiments the height dimension for the gutter retaining frame 14 may be larger or smaller than 4 inches, which may depend on the size dimensions of the gutter 68.

In some embodiments the gutter retaining frame 14 has a length dimension of approximately 4¾ inches. In alternative embodiments, the length dimension of the gutter retaining frame 14 may be larger or smaller than 4¾ inches, which may depend on the size dimensions of the gutter 68.

In some embodiments the gutter retaining frame 14 has a width dimension of approximately 1 inch. In alternative embodiments, the width dimension of the gutter retaining frame 14 may be larger or smaller than 1 inch, which may depend on the size dimensions of the gutter 68.

In some embodiments the gutter 68 used with the pivotal gutter bracket 10 may include flexible downspouts which do not interfere with the rotation of the pivotal gutter bracket 10 between the first operative position which receives moisture and the second operative position which is utilized to clean the gutter 68 and/or to remove debris.

In some embodiments the length dimension for the horizontal section 18 is selected to be approximately equal to the distance dimension of the outer edge of the gutter 68 from a roof 66. In some embodiments the distal working end 30 and the pivot retainer or pivot receiving channel 36 is disposed proximate to the outer end of the horizontal section 18 in order to minimize risk of in advertent rotation of the pivotal gutter bracket 10 between the first operative position and the second operative position. The placement of the distal working end 30 and the pivot retainer or pivot receiving channel 36 proximate to the outer end of the horizontal section 18 establishes an offset center of rotation, where the weight of the gutter 68 and the gutter retaining frame 14 is located proximate to a structure or roof 66, which in turn minimizes risk of in advertent rotation of the pivotal gutter bracket 10 towards the second operative cleaning position.

In some embodiments the pivot 58 is snap fit for frictional rotational engagement within the pivot retainer or pivot receiving channel 36, which in turn minimizes risk of inadvertent rotation of the pivotal gutter bracket 10 towards the second operative cleaning position. The offset positioning of the pivot 58 away from the structure or roof 66, in some embodiments results in the necessity for an individual to manually or automatically rotate the pivotal gutter bracket 10 from the second operative position upwardly into the first operative position.

It should be noted that the pivotal gutter bracket 10, as disclosed and described herein may be used with any size of gutter 68 as preferred by an individual.

In a first alternative embodiment a pivotal gutter bracket is disclosed, the pivotal gutter bracket comprising a support brace, the support brace comprising a vertical section and a horizontal section, the horizontal section having a distal working end comprising a pivot retainer or pivot receiving channel, the horizontal section having a lower surface and a gutter retaining frame, the gutter retaining frame comprising a pivot support and a pivot engaged to the pivot support, the pivot being rotatably engaged to the pivot retainer or pivot receiving channel, wherein the gutter bracket has a first operative position when the gutter retaining frame is disposed upwardly, and a second operative position where the gutter retaining frame is disposed downwardly to facilitate removal of debris from a gutter.

In a second alternative embodiment according to the first embodiment the distal working end further comprises a first prong and a second prong, the pivot retainer comprising a pivot receiving channel.

In a third alternative embodiment according to the second embodiment the horizontal section further comprises an axial channel between the first prong and the second prong.

In a fourth alternative embodiment according to the third embodiment the horizontal section further comprises an angled ramp.

In a fifth alternative embodiment according to the fourth embodiment the angled ramp extends from the axial channel proximate to the pivot retainer or pivot receiving channel downwardly and rearwardly toward the lower surface and the vertical section.

In a sixth alternative embodiment according to the fifth embodiment the gutter retaining frame further comprises an angled exterior bearing edge, wherein rotation of the gutter retaining frame from the first operative position to the second operative position rotates the angled exterior bearing edge within the axial channel and disposes the angled exterior bearing edge proximate to the angled ramp.

In a seventh alternative embodiment according to the sixth embodiment the gutter retaining frame further comprises at least one of a pocket, a first vertical wall, a second angled wall, a bottom, a third angled wall, and a fourth vertical wall.

In an eighth alternative embodiment according to the seventh embodiment the support brace further comprises at least one of a first vertical inner surface, a second angled inner surface, a third angled inner surface, and a fourth angled inner surface.

In a ninth alternative embodiment according to the eighth embodiment the gutter retaining frame further comprises at least one attachment hook.

In a tenth alternative embodiment according to the ninth embodiment the gutter retaining frame further comprises an angled bearing edge.

In an eleventh alternative embodiment according to the tenth embodiment the gutter retaining frame further comprises a first rail and a second rail.

In a twelfth alternative embodiment according to the sixth embodiment the gutter retaining frame further comprises a pocket, a first vertical wall, a second angled wall, a bottom, a third angled wall, and a fourth vertical wall.

In a thirtieth alternative embodiment according to the sixth embodiment the support brace further comprises a first vertical inner surface, a second angled inner surface, a third angled inner surface, and a fourth angled inner surface.

In a fourteenth alternative embodiment a pivotal gutter bracket is disclosed, the pivotal gutter bracket comprising a support brace, the support brace comprising a vertical section and a horizontal section, the horizontal section having a distal working end comprising a first prong and a second prong, the first prong and the second prong defining a pivot receiving channel, the horizontal section further comprising an axial channel between the first prong and the second prong and an angled ramp, and a gutter retaining frame, the gutter retaining frame comprising a pivot support and a pivot engaged to the pivot support, the pivot being rotatably engaged to the pivot receiving channel, the gutter retaining frame further comprising an angled exterior bearing edge wherein the gutter bracket has a first operative position when the gutter retaining frame is disposed upwardly, and a second operative position where the gutter retaining frame is disposed downwardly to facilitate removal of debris from a gutter, and further wherein rotation of the gutter retaining frame from the first operative position to the second operative position rotates the angled exterior bearing edge within the axial channel and disposes the angled exterior bearing edge proximate to the angled ramp.

This completes the description of the preferred and alternate embodiments of the invention. Those skilled in the art may recognize other equivalents to the specific embodiment described herein which equivalents are intended to be encompassed by the claims attached hereto.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

While the foregoing details what is felt to be the preferred embodiment of the invention, no material limitations to the scope of the claimed invention are intended. Further, features and design alternatives that would be obvious to one of ordinary skill in the art are considered to be incorporated herein. The scope of the invention is set forth and particularly described in the claims herein below.

What is claimed is:

1. A pivotal gutter bracket, said pivotal gutter bracket comprising:
a support brace, said support brace comprising a vertical section and a horizontal section, said horizontal section having a distal working end comprising a pivot retainer, said horizontal section having a lower surface; and
a gutter retaining frame, said gutter retaining frame comprising a pivot support and a pivot engaged to said pivot support, said pivot being rotatably engaged to said pivot retainer, wherein said gutter bracket has a first operative position when said gutter retaining frame is disposed upwardly, and a second operative position where said gutter retaining frame is disposed downwardly to facilitate removal of debris from a gutter.

2. The pivotal gutter bracket according to claim 1, said working end further comprising a first prong and a second prong, said pivot retainer comprising a pivot receiving channel.

3. The pivotal gutter bracket according to claim 2, said horizontal section further comprising an axial channel between said first prong and said second prong.

4. The pivotal gutter bracket according to claim 3, said horizontal section further comprising an angled ramp.

5. The pivotal gutter bracket according to claim 4, wherein said angled ramp extends from said axial channel proximate to said pivot receiving channel downwardly and rearwardly toward said lower surface and said vertical section.

6. The pivotal gutter bracket according to claim 5, said gutter retaining frame further comprising an angled exterior bearing edge, wherein rotation of said gutter retaining frame from said first operative position to said second operative position rotates said angled exterior bearing edge within said axial channel and disposes said angled exterior bearing edge proximate to said angled ramp.

7. The pivotal gutter bracket according to claim 6, said gutter retaining frame further comprising at least one of a pocket, a first vertical wall, a second angled wall, a bottom, a third angled wall, and a fourth vertical wall.

8. The pivotal gutter bracket according to claim 7, said support brace further comprising at least one of a first vertical inner surface, a second angled inner surface, a third angled inner surface, and a fourth angled inner surface.

9. The pivotal gutter bracket according to claim 8, said gutter retaining frame further comprising at least one attachment hook.

10. The pivotal gutter bracket according to claim 9, said gutter retaining frame further comprising an angled bearing edge.

11. The pivotal gutter bracket according to claim 10, said gutter retaining frame further comprising a first rail and a second rail.

12. The pivotal gutter bracket according to claim 6, said gutter retaining frame further comprising a pocket, a first vertical wall, a second angled wall, a bottom, a third angled wall, and a fourth vertical wall.

13. The pivotal gutter bracket according to claim 6, said support brace further comprising a first vertical inner surface, a second angled inner surface, a third angled inner surface, and a fourth angled inner surface.

14. A pivotal gutter bracket, said pivotal gutter bracket comprising:
a support brace, said support brace comprising a vertical section and a horizontal section, said horizontal section having a distal working end comprising a first prong and a second prong, said first prong and said second prong defining a pivot receiving channel, said horizontal section further comprising an axial channel between said first prong and said second prong and an angled ramp; and
a gutter retaining frame, said gutter retaining frame comprising a pivot support and a pivot engaged to said pivot support, said pivot being rotatably engaged to said pivot receiving channel, said gutter retaining frame further comprising an angled exterior bearing edge wherein said gutter retaining frame has a first operative position when said gutter retaining frame is disposed upwardly, and a second operative position where said gutter retaining frame is disposed downwardly to facilitate removal of debris from a gutter, and further wherein rotation of said gutter retaining frame from said first operative position to said second operative position rotates said angled exterior bearing edge within said axial channel and disposes said angled exterior bearing edge proximate to said angled ramp.
